(19) United States
(12) Patent Application Publication
(10) Pub. No.: US 2014/0337430 A1
(43) Pub. Date: Nov. 13, 2014

(54) METHOD FOR CONTENT TRANSMISSION USING SOCIAL INFORMATION

(71) Applicant: Electronics and Telecommunications Research Institute, Daejeon-si (KR)

(72) Inventors: Seng-Kyoun JO, Chungcheongbuk-do (KR); Kyoung-Hee LEE, Daejeon-si (KR); Hyun- Woo LEE, Daejeon-si (KR); Won RYU, Daejeon-si (KR)

(73) Assignee: Electronics and Telecommunications Research Institute, Daejeon-si (KR)

(21) Appl. No.: 14/100,700

(22) Filed: Dec. 9, 2013

(30) Foreign Application Priority Data
May 10, 2013 (KR) 10-2013-0053285

(51) Int. Cl. H04L 29/12; H04L 29/08

(52) U.S. Cl. CPC H04L 61/2069; H04L 67/30
USPC 709/204

(57) ABSTRACT

A method for efficiently transmitting contents on a network is provided. The content transmission method using social information, includes: requesting content registration and social information of a user; allocating, by a social information management node, a multicast address to be used in content transmission based on the content registration information and social information received from a social service provider; transmitting the allocated multicast address to a first access control node to which a first user terminal is connected so as to set the first access control node as a multicast source, in response to a request of the first access control node; and transmitting a response message to a second access control node for setting a multicast transmission path for content transmission between the first access control node and the second access control node when there is a sharing request of the second access control node.

### CROSS-REFERENCE TO RELATED APPLICATION(S)

This application claims priority to and the benefit of Korean Patent Application No. 10-2013-0053285, filed on May 10, 2013, the disclosure of which is incorporated herein by reference in its entirety.

### BACKGROUND

1. Field

The present invention relates to network service technologies, and more particular, to a method for efficiently transmitting contents on a network.

2. Description of the Related Art

Services that strengthen online human relationships with friends, acquaintances, co-workers, etc., and establish new human relationships to form a wide human networking are referred to as social network services (SNS). As representative SNS, Twitter, Cyworld, Facebook, and the like may be given. Initial SNS is a method in which short messages based on texts with low capacity are shared between users in the form of conversation. However, recent SNS provides services which mutually share various high quality social media between users through combination with applications such as social television (TV). In this manner, with the development of the SNS, the number of subscribers has been greatly increased to about more than one billion people in the present from about 800 million people in 2010 around the world. In case of Facebook that is currently considered leading SNS, the recent average number of daily visitors reaches 310 million people. As SNS spreads in this manner, an amount of contents for SNS has been also significantly increased. However, from the perspective of a network, it can be seen that importance of traffic that occurs due to social services from total traffic has been significantly increased. Thus, in this environment, a content transmission method only for SNS is required for more efficient utilization of network resources, which is differentiated from the existing method. However, the conventional network transmission method is basically performed in a router of the network based on an Internet protocol (IP) address of a packet, and therefore traffic that occurs due to SNS and general traffic are handled without distinction.

In addition, in recent years, with the emergence of high-performance terminals such as smart phones, contents shared through SNS have been evolved from the form of texts and pictures to the form of high-capacity contents with high image quality which are created or held by a user. Thus, in order to share such high-capacity contents, a content transmission method is required, which is differentiated from the existing method. However, in the conventional content transmission method, in order to share high-capacity contents created or held by the user with other users, the high-capacity contents are uploaded to a storage server allocated by a service provider, and the other users download the uploaded contents.

However, in the conventional content transmission method, burden of the network depending on upload/download is increased along with an increase in the capacity of contents. In addition, the conventional content transmission method is performed with respect to contents most of which are video-on-demand, and therefore there is difficulty in applying to real-time contents such as private broadcasting or personal casting.

Republic of Korea Publication No. 10-2012-0011803

### SUMMARY

The present invention is directed to a method for efficiently transmitting contents for efficient utilization of network resources in such a manner that social information of users are utilized in a network to set a multicast transmission path specified in social contents.

According to an aspect of the present invention, there is provided a content transmission method using social information, including: requesting, by a social information management node in conjunction with a social service provider, content registration and social information of a user from the social service provider based on a content registration request message received from a first user terminal having contents; allocating, by the social information management node, a multicast address to be used in content transmission based on the content registration information and social information received from the social service provider;

transmitting, by the social information management node, the allocated multicast address to a first access control node to which the first user terminal is connected so as to set the first access control node as a multicast source, in response to a request of the first access control node; and transmitting, by the social information management node, a response message for setting a multicast transmission path for content transmission between the first access control node and a second access control node to which a second user terminal requesting content sharing is connected, to the second access control node when there is a sharing request of the second access control node.

Here, the contents may be real-time contents created in the first user terminal.

Also, the content registration request message may include an identifier for identifying the user terminal, a social service type, and identification information for identifying the social information.

Also, the content registration information may include a content identifier that is allocated by the social service provider so as to distinguish the corresponding contents from other contents within social services.

Also, the social information may be a human relationship of a user's social relationship.

Also, the response message for setting the multicast transmission path may include the allocated multicast address and information of the first access control node in which the first user terminal is located.

Also, the transmitting of the allocated multicast address may include setting, by the first access control node, the first access control node as the multicast source with respect to the transmitted multicast address using a predefined multicast protocol.

Also, the transmitting of the response message may include transmitting, by the second access control node, a transmission path setting request message to the first access control node based on the transmitted response message, and setting, by the first access control node, a multicast transmission path with the second access control node with respect to a specific multicast group address.

Also, the transmission path setting request message may be a JOIN message defined in a protocol independent multicast (PIM).

Also, the setting of the multicast transmission path may include transmitting the contents using the set multicast transmission path.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 illustrates a content transmission system according to an embodiment of the present invention;

FIG. 2 is a flowchart illustrating a content transmission method using social information according to an embodiment of the present invention;

FIG. 3 is a flowchart illustrating a content registration and social information request operation according to an embodiment of the present invention;

FIG. 4 is a flowchart illustrating a multicast address allocation operation according to an embodiment of the present invention;

FIG. 5 illustrates an example of a social information management table prior to content registration according to an embodiment of the present invention;

FIG. 6 is a flowchart illustrating a multicast group source setting operation according to an embodiment of the present invention; and

FIG. 7 is a flowchart illustrating a multicast transmission path setting operation according to an embodiment of the present invention.

### DETAILED DESCRIPTION

Exemplary embodiments of the present invention will be described in detail below with reference to the accompanying drawings. While the present invention is shown and described in connection with exemplary embodiments thereof, it will be apparent to those skilled in the art that various modifications can be made without departing from the spirit and scope of the invention.

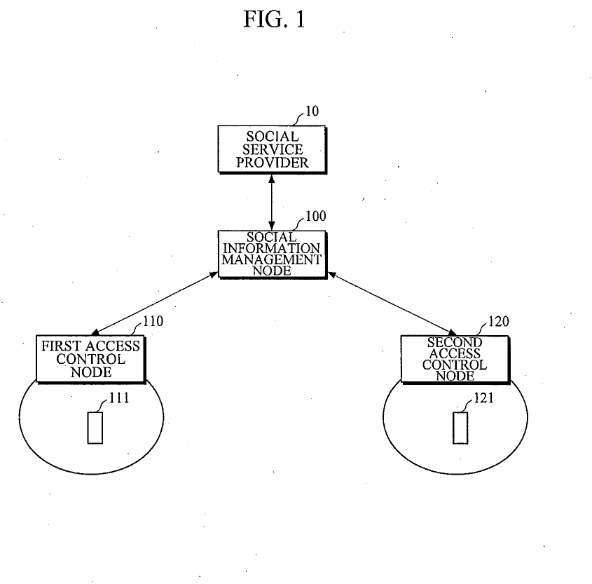

FIG. 1 illustrates a content transmission system according to an embodiment of the present invention. Referring to FIG. 1, the content transmission system includes a social service provider 10, a social information management node 100, access control nodes 110 and 120, and user terminals 111 and 121.

First, the social service provider 10 denotes a provider that provides social network services (SNS). For example, the social service provider 10 may be provider that provides services such as Twitter, Facebook, and the like. According to an embodiment of the present invention, there may be provided at least one social service provider 10.

Next, the social information management node 100 is located on a network, inquires/responds with social information of a user in conjunction with various social service providers, and manages the inquired and responded results using a social information management table.

Next, the access control nodes 110 and 120 are located on a single access network, and mange location information and social information of a plurality of user terminals which exist in sub-networks. In addition, the access control nodes 110 and 120 provide a function that sets a multicast transmission path with other access control nodes based on social information for the purpose of content transmission, and include a networking function capable of actually processing this. A large number of access control nodes may exist in a single physical access network in accordance with a range of the network.

Next, the user terminals 111 and 121 denote a terminal that can create and share contents. For example, the user terminals 111 and 121 may include mobile terminals such as a cellular phone, a smart phone, personal digital assistants (PDA), and the like. Here, the user refers to a social network service subscriber. According to an embodiment of the present invention, the user terminals 111 and 121 may share contents created by itself with other terminals. According to another embodiment of the present invention, the user terminals 111 and 121 may share contents created in advance and stored with other user terminals.

Hereinafter, for convenience of description, a user terminal that requests content registration is defined as a first user terminal 111, and it is assumed that the first user terminal 111 exists in a sub-network of the first access control node 110. A user terminal that shares contents which are created by a user 1 and registered in a social service provider is defined as a second user terminal 121, and it is assumed that the second user terminal 121 exists in a sub-network of the second access control node 120.

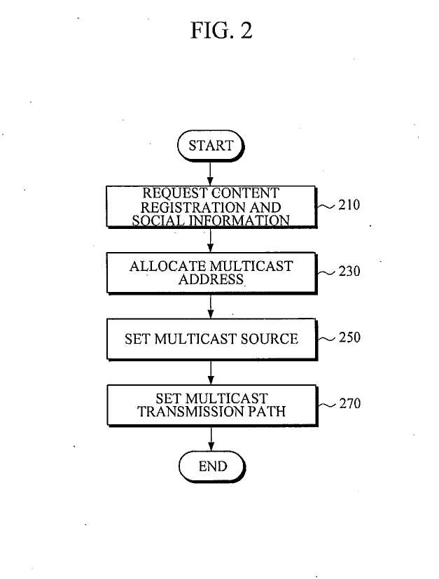

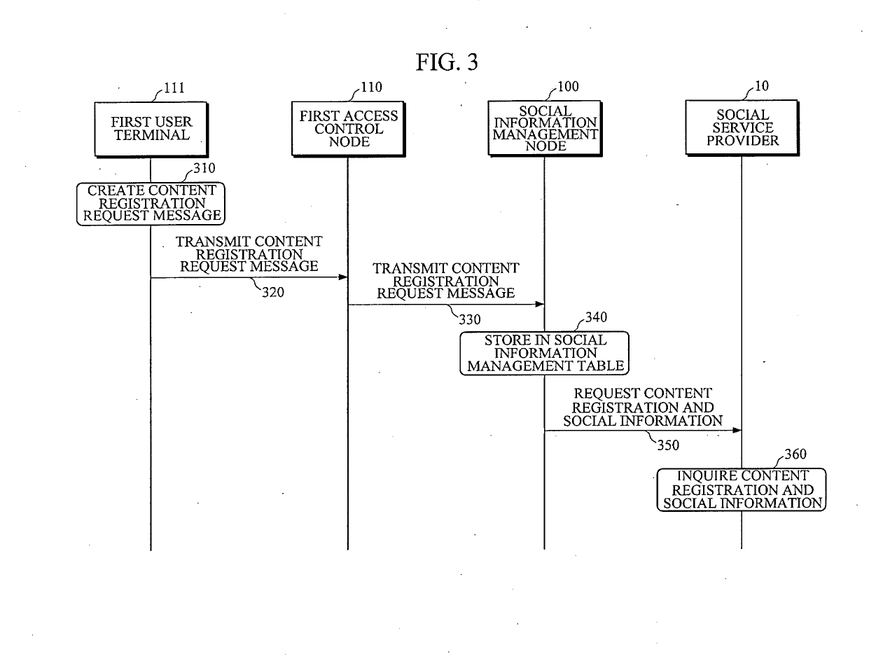

FIG. 2 is a flowchart illustrating a content transmission method using social information according to an embodiment of the present invention. Referring to FIG. 2, a method of transmitting contents using social information will be described focusing on the social information management node 100. In operation 210, the social information management node 100 requests content registration and social information of a user from the social service provider 10 based on a content registration request message received from the first user terminal 111 that creates contents. Next, the social service provider 10 inquires the social information of the user, and registers the contents. This will be described in detail later with reference to FIG. 3.

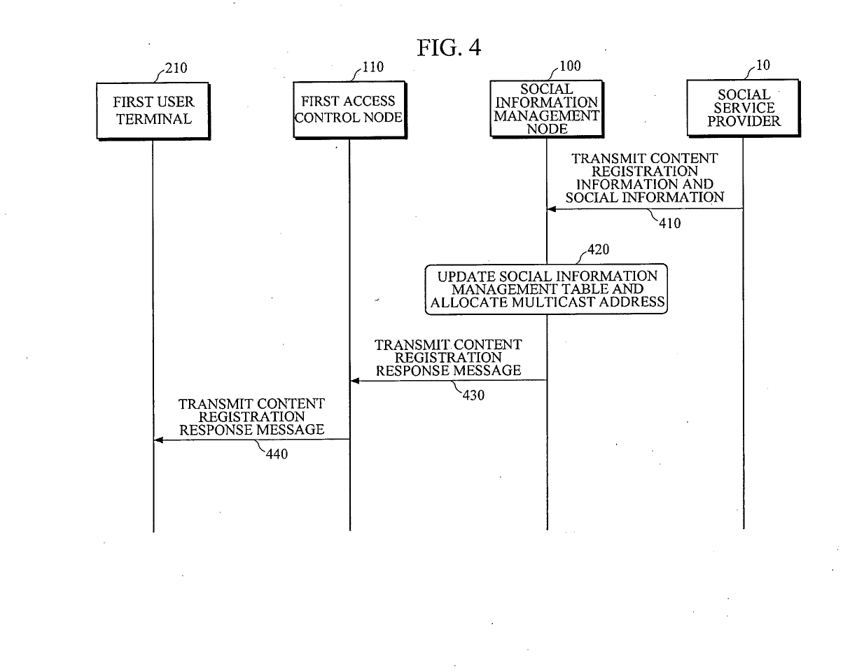

Next, in operation 230, the social information management node 100 allocates a multicast address to be used in transmission of the contents which are registered based on the content registration information and the social information received from the social service provider 10. Next, the social information management node 100 transmits a content registration response message for notifying that the contents are normally registered. This will be described in detail later with reference to FIG. 4.

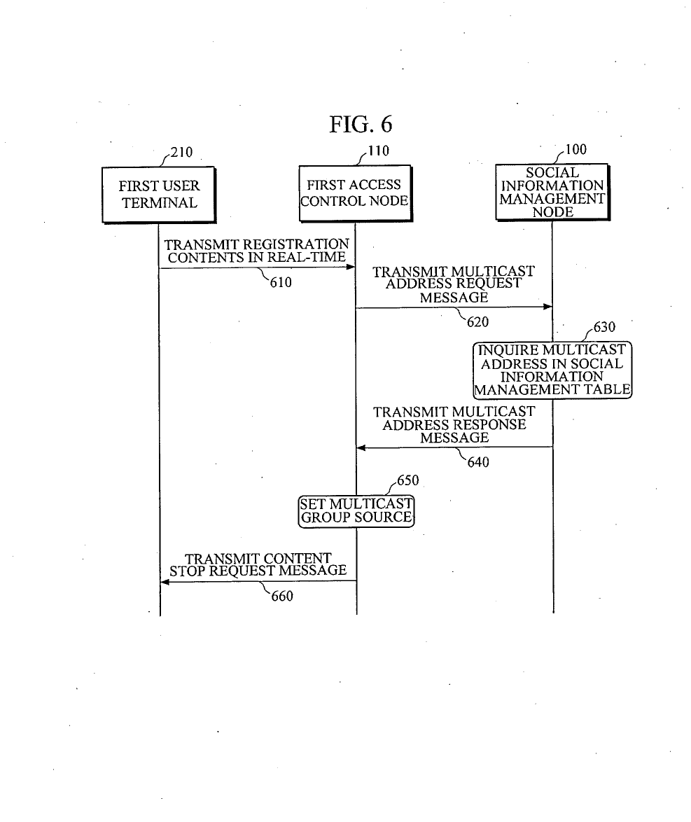

Next, in operation 230, the social information management node 100 transmits the allocated multicast address so as to set the first access control node 110 as a multicast source, in response to a request of the first access control node 110 to which the first user terminal 111 is connected. This will be described in detail later with reference to FIG. 6.

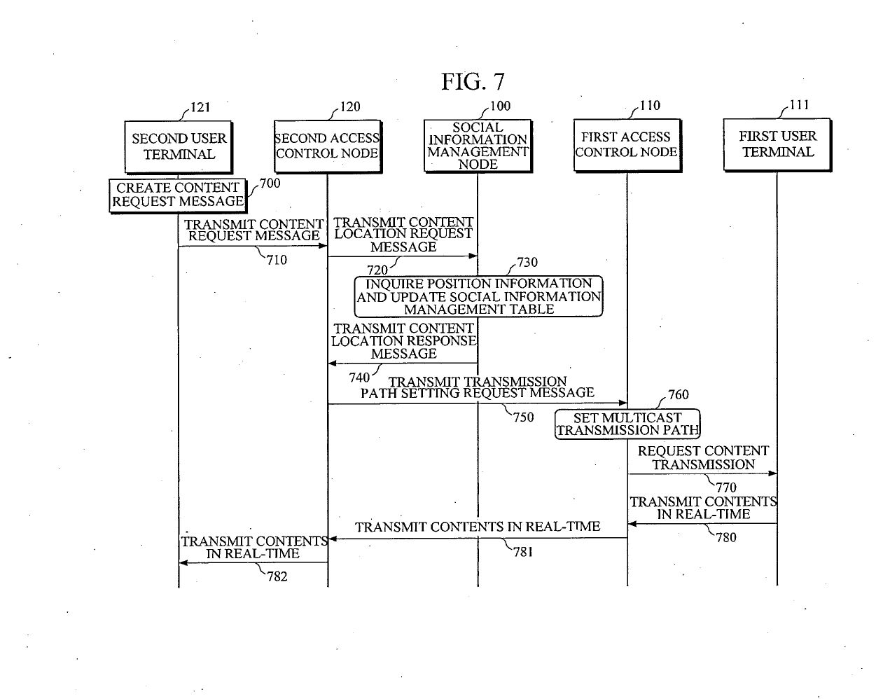

Next, the social information management node 100 transmits a response message for setting a multicast transmission path with the first access control node 110 when there is a sharing request of the second access control node 120 to which the second user terminal 121 that requests content sharing is connected. Next, the second access control node 120 transmits a transmission path setting request message to the first access control node 110 based on the received response message. Next, the first access control node 110 sets a multicast transmission path with the second access control node 120 with respect to a specific multicast group address. This will be described in detail later with reference to FIG. 7.

FIG. 3 is a flowchart illustrating a content registration and social information requesting operation according to an embodiment of the present invention. The content registration requesting operation refers to an operation of requesting content registration from the social service provider in order to share the contents created by the user with other users in a social relationship with the user, and its related processing operation. Here, the social relationship refers to all social relationships of the user. For example, the social relationship may be a friend relationship of the user. For example, the social relationship may be a human relationship in which hobbies, interests, affiliations, and the like are shared between the user and other users. For example, the social relationship may be a social graph obtained by analyzing a social profile of the user.

Referring to FIG. 3, the content registration and social information requesting operation will be described in detail. First, in operation 310, the first user terminal 111 creates a content registration request message for content registration. Here, the content registration request message may include an identifier and identification information. In this instance, the identifier refers to information for identifying the user from others users. For example, the identifier may be a user ID and password (PW) of social network services. In this instance, the identification information refers to information for identifying social services, social information, and the like. For example, the social information may include “content creator”, “social service type”, “social relationship”, “content title”, or the like. That is, the social information may be “skjo@abc.com/password”, “www.facebook.com”, “friends”, “personal broadcasting”, or the like.

Next, in operation 320, the first user terminal 111 transmits the content registration request message to the first access control node to which the first user terminal 111 is connected.

Next, in operation 330, the first access control node 110 transmits, to the social information management node, the content registration request message received from the first user terminal.

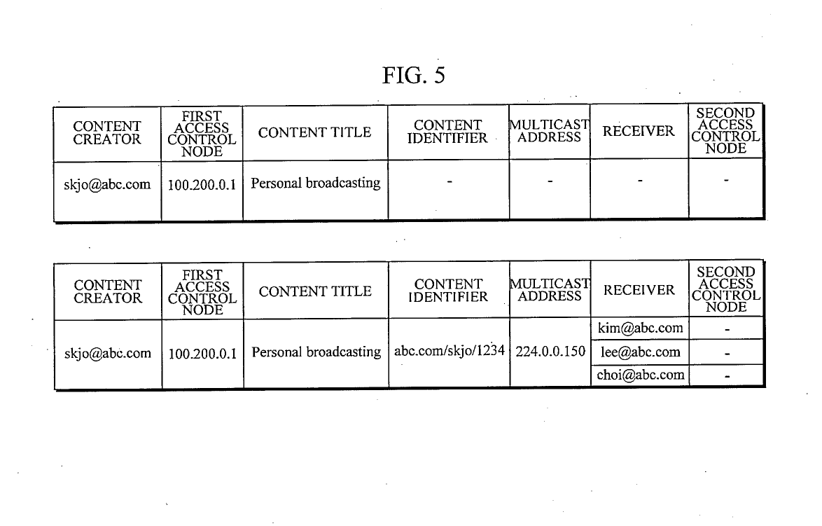

Next, in operation 340, the social information management node 100 inputs, in the social information management table, information included in the content registration request message received from the first access control node 110. The social information management table is shown in FIG. 5.

Next, in operation 350, the social information management node 100 requests the content registration and the social information of the user from the social service provider 10 based on the content registration request message received from the first access control node 110.

Next, in operation 360, the social service provider 10 inquires the social information of the user, and registers the contents. More specifically, the social service provider completes a service authentication procedure with respect to the user using an identifier included in the content registration request message. For example, the social service provider completes the service authentication procedure with respect to the user using ID/PW of the user which is the identifier. Next, the social service provider inquires the social information requested by the user, using the identification information included in the content registration request message. For example, the social service provider inquires a list of other user IDs in a friend relationship with the user within the social network service. Next, the social service provider registers the contents, and allocates the content identifier in order to distinguish the corresponding contents from other contents within the social service. Next, the social service provider notifies to other user terminals the fact that the contents have been registered in a predetermined method. For example, the social service provider may perform online notification to the other user terminals that the contents have been registered.

FIG. 4 is a flowchart illustrating a multicast address allocation operation according to an embodiment of the present invention. First, in operation 410, the social service provider 10 transmits, to the social information management node 100, the content registration information including the content identifier and the inquired social information. Next, in operation 420, the social information management node 100 updates the received information in the social information management table, and allocates a multicast address to be used in multicast transmission of the registered contents. Here, the allocation of the multicast address is performed by a predefined method, and is not limited to a specific method.

Next, in operation 430, the social information management node 100 transmits a content registration response message for notifying that the contents are normally registered to the first access control node 110.

Next, in operation 440, the first access control node transmits the content registration response message to the first user terminal 111.

FIG. 5 illustrates an example of a social information management table prior to content registration according to an embodiment of the present invention. In FIG. 5, an upper table is an example of the social information management table prior to content registration. In the upper social information management table, information included in the content registration request message is stored. A lower table of FIG. 5 is an example of the social information management table posterior to the content registration. In the lower social information management table, the content identifier, receiver information, and the allocated multicast address which are received from the social information management node are stored.

FIG. 6 is a flowchart illustrating a multicast group source setting operation according to an embodiment of the present invention. First, in operation 610, the first user terminal 111 transmits the registered contents to the first access control node 110 in real-time.

Next, in operation 620, the first access control node 110 transmits, to the social information management node 100, a multicast address request message for requesting the multicast address for setting a multicast transmission path. Here, the multicast address request message includes a content identifier.

Next, in operation 630, the social information management node 100 inquires the multicast address allocated to the corresponding content identifier in the social information management table based on the received multicast address request message.

Next, in operation 640, the social information management node 100 transmits a multicast address response message including the inquired multicast address to the first access control node 110.

Next, in operation 650, the first access control node 110 sets the first access control node 110 as a multicast source with respect to the corresponding multicast address. Here, the multicast source refers to a node that multicasts a data packet in a node that the multicast source joins in a multicast group providing multicast services. The setting of the multicast source according to an embodiment of the present invention may be performed using a multicast protocol (PIM; protocol independent multicast) that is a path selection protocol which is used to transmit and receive the multicast packet when performing multicast on an IP network. In particular, as a method of specifying a specific source, a source specific multicast (SSM) may be used. The setting of the multicast source according to another embodiment may be a multicast router setting method.

Next, in operation 660, when there is no request for sharing of the registered contents from the second user terminal 121, the first access control node 110 transmits a content transmission stop request message to the first user terminal 111. Through this, the first user terminal 111 continuously creates contents in real-time through an input device, but the created contents are not transmitted on an actual network.

FIG. 7 is a flowchart illustrating a multicast transmission path setting operation according to an embodiment of the present invention. First, in operation 700, the second user terminal 121 creates a content sharing request message for content sharing. Here, the content sharing request message includes identification information of the second user terminal and a content identifier for identifying the registered contents notified by the social service provider.

Next, in operation 710, the second user terminal 121 transmits the content sharing request message to the connected second access control node 120.

Next, in operation 720, the second access control node 120 transmits, to the social information management node, a content location request message for ascertaining a location of the first user terminal. Here, the content location request message includes identification information of the second user terminal, the content identifier, and location information of the second access control node.

Next, in operation 730, the social information management node 100 inquires location information of the first user terminal based on the received content location request message, and updates the social information management table. More specifically, the social information management node 100 inquires the social information management table based on the received content location request message to ascertain the first access control node 110 and the multicast address which correspond to the corresponding content identification information, and updates access control node information corresponding to the identification information of the second user terminal 121 in the social information management table.

Next, in operation 740, the social information management node 100 transmits a content location response message to the second access control node 120. Here, the content location response message includes the multicast address of the contents created in the first user terminal 111 and information of the first access control node 110 to which the first user terminal 111 is connected.

Next, in operation 750, the second access control node 120 transmits a transmission path setting request message to the first access control node 110 based on the received content location response message. Here, the transmission path setting request message may be a JOIN message defined in a PIM. In this instance, a multicast source address is an address of the first access control node 110 that is set as the multicast source, and as a subscriber group address, an allocated multicast group address may be used.

Next, in operation 760, the first access control node 110 sets a multicast transmission path with the second access control node 120 with respect to a specific multicast group address. In this instance, a network node (router) that can provide a plurality of multicast functions between the two access control nodes may be included on the path.

Next, in operation 770, the first access control node 110 determines presence of a user desiring to share the real-time contents created by the first user terminal 111, and requests content transmission from the first user terminal.

Next, in operation 780, the first user terminal transmits the contents to the first access control node in real-time.

Next, in operation 781, the first access control node transmits the contents in real-time by setting the first access control node as a source of the group using the created multicast transmission path.

Next, in operation 782, the second access control node transmits the contents to the second user terminal using a unicast transmission method.

As described above, according to the embodiments of the present invention, a specific multicast transmission path is set in social contents by utilizing social information of a user in a network to transmit contents, and therefore resources of the network used in content transmission may be efficiently managed.

In addition, multicast transmission path setting is performed between network nodes, and therefore the present invention may be applied to various application service fields without a separate additional function for multicast in a user terminal.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. A content transmission method using social information, comprising:
requesting, by a social information management node in conjunction with a social service provider, content registration and social information of a user from the social service provider based on a content registration request message received from a first user terminal having contents;
allocating, by the social information management node, a multicast address to be used in content transmission based on the content registration information and social information received from the social service provider;
transmitting, by the social information management node, the allocated multicast address to a first access control node to which the first user terminal is connected so as to set the first access control node as a multicast source, in response to a request of the first access control node; and
transmitting, by the social information management node, a response message for setting a multicast transmission path for content transmission between the first access control node and a second access control node to which a second user terminal requesting content sharing is connected, to the second access control node when there is a sharing request of the second access control node.

2. The content transmission method of claim 1, wherein the contents are real-time contents created in the first user terminal.

3. The content transmission method of claim 1, wherein the content registration request message includes an identifier for identifying the user terminal, a social service type, and identification information for identifying the social information.

4. The content transmission method of claim 1, wherein the content registration information includes a content identifier that is allocated by the social service provider so as to distinguish the corresponding contents from other contents within social services.

5. The content transmission method of claim 1, wherein the social information is a human relationship of a user's social relationship.

6. The content transmission method of claim 1, wherein the response message for setting the multicast transmission path includes the allocated multicast address and information of the first access control node in which the first user terminal is located.

7. The content transmission method of claim 1, wherein the transmitting of the allocated multicast address includes:
setting, by the first access control node, the first access control node as the multicast source with respect to the transmitted multicast address using a predefined multicast protocol.

8. The content transmission method of claim 1, wherein the transmitting of the response message includes:
transmitting, by the second access control node, a transmission path setting request message to the first access control node based on the transmitted response message; and
setting, by the first access control node, a multicast transmission path with the second access control node with respect to a specific multicast group address.

9. The content transmission method of claim 8, wherein the transmission path setting request message is a JOIN message defined in a protocol independent multicast (PIM).

10. The content transmission method of claim 8, wherein the setting of the multicast transmission path includes:
transmitting the contents using the set multicast transmission path.
